(19) United States
(12) Patent Application Publication
(10) Pub. No.: US 2022/0261722 A1
(43) Pub. Date: Aug. 18, 2022

(54) AGRICULTURAL SUPPLY CHAIN OPTIMIZER

(71) Applicant: International Business Machines Corporation, Armonk, NY (US)

(72) Inventor: Sarbajit K. Rakshit, Kolkata (IN)

(21) Appl. No.: 17/175,073

(22) Filed: Feb. 12, 2021

(51) Int. Cl. G06Q 10/06; G06Q 30/06; G06Q 10/08; G06N 20/00; G06N 5/04

(52) U.S. Cl. CPC G06Q 10/06313; G06Q 30/0633; G06Q 10/08355; G06N 5/04; G06Q 30/0631; G06Q 10/06315; G06N 20/00; G06Q 10/087

(57) ABSTRACT

According to embodiments of the present disclosure, a method, computer program product, and artificial intelligence enabled system. The method may comprise receiving, by a network interface, a customer order for a food item. The customer order may include a desired taste profile and a desired future consumption date range. The method may further comprise automatically identifying, by an artificial intelligence enabled system (AICS), one or more compatible combinations of delivery routes and delivery items responsive to the customer order, automatically selecting, by the AICS, a preferred delivery route and a preferred delivery item from among the one or more compatible combinations based at least in part on the desired taste profile and the desired future consumption date range, and sending, by the network interface, instructions to route the preferred delivery item to the customer using the preferred delivery route.

### BACKGROUND

The present disclosure relates to supply chain optimization, and more specifically, to computer systems that optimize supply chains to deliver food items having a specified taste profile.

A large number of factors can influence the taste and flavor of fruits, vegetables, and other crops. For example, apples grown from various cultivators of apple tree may be either sweet or sour, firm or soft, shelf stable or transient. Similarly, grapes grown in one type of soil and micro-climate can have markedly different taste profiles from grapes gown only a few miles away.

Farming history can also affect taste. For example, taste can vary depending on the weather conditions when a particular crop was planted, various decisions made during the growing season (e.g., soil, watering, fertilizer, preservative, etc.), and when in the growing cycle they were harvested. Similarly, the processing lifecycle of the fruit or vegetable (e.g., mode of transportation, duration of transportation, precaution(s) used during transportation, preservation methods used, etc.) will affect the quality of the resulting product.

Taken together, fruits, vegetables, and other crops often have significantly different tastes and flavors, even if from the same species of plant.

### SUMMARY

According to embodiments of the present disclosure, a method comprising receiving, by a network interface, a customer order for a food item. The customer order may include a desired taste profile and a desired future consumption date range. The method may further comprise automatically identifying, by an artificial intelligence enabled system (AICS), one or more compatible combinations of delivery routes and delivery items responsive to the customer order, automatically selecting, by the AICS, a preferred delivery route and a preferred delivery item from among the one or more compatible combinations based at least in part on the desired taste profile and the desired future consumption date range, and sending, by the network interface, instructions to route the preferred delivery item to the customer using the preferred delivery route.

According to embodiments of the present disclosure, a computer program product comprising a computer readable storage medium having program instructions embodied therewith. The program instructions may be executable by a processor to cause the processor to receive labeled data from a blockchain. The labeled data comprises vectors comprising historic taste profiles, transportation duration, modes of transportation, geo-location where the food items were cultivated, and weather condition during a growth cycle of the food item. The computer readable storage medium may further comprise program instructions to receive a customer order for a food item. The customer order may include a desired taste profile and a desired future consumption date range. The desired consumption date may comprise an estimated rate of consumption and a desired consumption date range, and the desired taste profile may comprise a reference food item that the customer has previously received. The computer readable storage medium may further comprise program instructions to calculate an amount of food items that can be delivered in a single transit consistent with the desired taste profile through the desired consumption date range using the labeled data, identify one or more maturity states of the food items to satisfy the desired taste profile on the desired future consumption date based at least in part on the calculated amount of food items and the labeled data, and automatically identify one or more compatible combinations of delivery routes and delivery items responsive to the customer order based at least in part on the one or more maturity states, a compatible growth source location, a compatible mode of transportation, a compatible supply chain route, a compatible type of preparation, and a compatible preservation method to satisfy the desired taste profile. The computer readable storage medium may further comprise program instructions to automatically select a preferred delivery route and one or more preferred delivery items from among the one or more compatible combinations based at least in part on the desired taste profile and the desired future consumption date range, and send instructions to route the preferred delivery item to the customer using the preferred delivery route.

According to embodiments of the present disclosure, an artificial intelligence enabled system (AIES) comprising a processor configured to execute instructions that, when executed on the processor, cause the processor to receive a customer order for a food item. The customer order may include a desired taste profile and a desired future consumption date range. The system may further comprise instructions that cause the processor to automatically identify one or more compatible combinations of delivery routes and delivery items responsive to the customer order, automatically select a preferred delivery route and a preferred delivery item from among the one or more compatible combinations based at least in part on the desired taste profile and the desired future consumption date range, and sending instructions to route the preferred delivery item to the customer using the preferred delivery route.

The above summary is not intended to describe each illustrated embodiment or every implementation of the present disclosure.

### BRIEF DESCRIPTION OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 illustrates an embodiment of a data processing system (DPS), consistent with some embodiments.

FIG. 2 depicts a cloud computing environment, consistent with some embodiments.

FIG. 3 depicts abstraction model layers, consistent with some embodiments.

FIG. 4 is a system diagram for the supply chain optimizer, consistent with some embodiments.

FIG. 5 is a flow chart illustrating one method of training the supply chain optimizer, consistent with some embodiments.

FIG. 6 is a flow chart of an execution phase of the supply chain optimizer, consistent with some embodiments.

FIG. 7A depicts an example blockchain architecture configuration, consistent with some embodiments.

FIG. 7B illustrates a blockchain transactional flow, consistent with some embodiments.

FIG. 8A illustrates a flow diagram, consistent with some embodiments.

FIG. 8B illustrates a further flow diagram, consistent with some embodiments.

FIG. 8C illustrates an example system configured to perform one or more operations described herein, consistent with some embodiments.

FIG. 8D illustrates another example system configured to perform one or more operations described herein, consistent with some embodiments.

FIG. 8E illustrates a further example system configured to utilize a smart contract, consistent with some embodiments.

FIG. 8F illustrates a system including a blockchain, consistent with some embodiments.

FIG. 9A illustrates a process for a new block being added to a distributed ledger, according to example embodiments.

FIG. 9B illustrates contents of a new data block, according to example embodiments.

FIG. 9C illustrates a blockchain for digital content, according to example embodiments.

FIG. 9D illustrates a block which may represent the structure of blocks in the blockchain, according to example embodiments.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION

Aspects of the present disclosure relate to supply chain optimization; more particular aspects relate to computer systems that optimize supply chains to deliver food items having a specified taste profile. While the present disclosure is not necessarily limited to such applications, various aspects of the disclosure may be appreciated through a discussion of various examples using this context.

Many factors can affect the taste and smell (“flavor profile”) of a food item, such as transportation duration, how it was transported, types and method of preservation, when it was harvested during the growth cycle, the terroir where the food item was grown or raised, weather conditions during the growth cycle, etc. This variability may cause problems if the customer desires, or even requires, a particular flavor profile and/or a consistent flavor profile.

Accordingly, some embodiments of this disclosure provide a method and system to identify specific food items and to calculate an optimized supply chain route for those specific items such that the customer has the best chance of receiving a food item having the desired smell and taste. Some embodiments may include a method and system by which a customer can specify its desired flavor profile and consumption date(s) for the food item(s) while ordering the product(s) e.g., online. In response, an artificial intelligence (AI) enabled system may identify one or more specific food item(s) and supply chains that are compatible with the specified flavor profile and consumption date(s). Some embodiments may further identify specific food items at varying maturity states to support optimal flavor over a consumption date range.

In some embodiments, while ordering any food item online, a customer can specify the desired taste and flavor of a food item by providing a reference food item (e.g., a recently consumed food item) for which they want to get a same or similar taste and flavor. Additionally or alternatively, the customer may specify a reference smell and flavor of the food item detected with electronic nose or taste measuring system, or may generate a profile of “likes” that can be used to calculate a preferred taste profile for the user for a variety of different food items.

In some embodiments, the customer may specify a particular desired delivery date for the food items. Additionally or alternatively, the customer may specify a consumption schedule (e.g., a rate of consumption of the food items). The AI enabled system may then calculate a maximum number of food items that can be delivered in a single delivery, consistent with the desired taste profile and consumption schedule. Some embodiments may identify a plurality of individual items at different maturity states such that those food items will obtain the desired taste and smell according to the consumption schedule.

Some embodiments may receive an order from customer, and in response, select optimal specific food items in view of their individual transportation duration, mode of transportation, geo-location where the fruit/vegetable were cultivated, weather condition during the growth cycle, etc.

In some embodiment, an AI engine executing on the AI enabled system may first identify a plurality of compatible combinations of delivery routes and delivery items responsive to the customer order, and then select the individual food items from the identified combinations. This may include identifying appropriate maturity state(s) for the food item in a delivery so that the customer will most likely be able to consume individual food item having the desired taste profile. Additionally, as food items may delivered in a single order that will be consumed over a period of consumption cycle, the AI engine can generate recommendations on how the food items should be preserved, and at what sequence the food items should be consumed, so that the customer can get required taste and flavor in some embodiments. The AI engine may transmit these recommendations to the customer in response to the order and/or in response to delivery.

The AI engine in some embodiments may, using historical learning, predict how the taste and smell profile food items may change over a period of a time, and as a function of events such as during transportation, mode of transportation, types of preserve, weather condition during the growth cycle, timing of harvesting, maturity state of harvesting, etc., and will be recommending which fruits/vegetables are to be delivered to the customer. Other parameters that may be used in the models include growth geo-location and sequence of different crop cultivation. A blockchain may be used for tracing data vectors used to generate these predictions, as well as to store an order or billing detail to provide flavor reference.

### Data Processing System

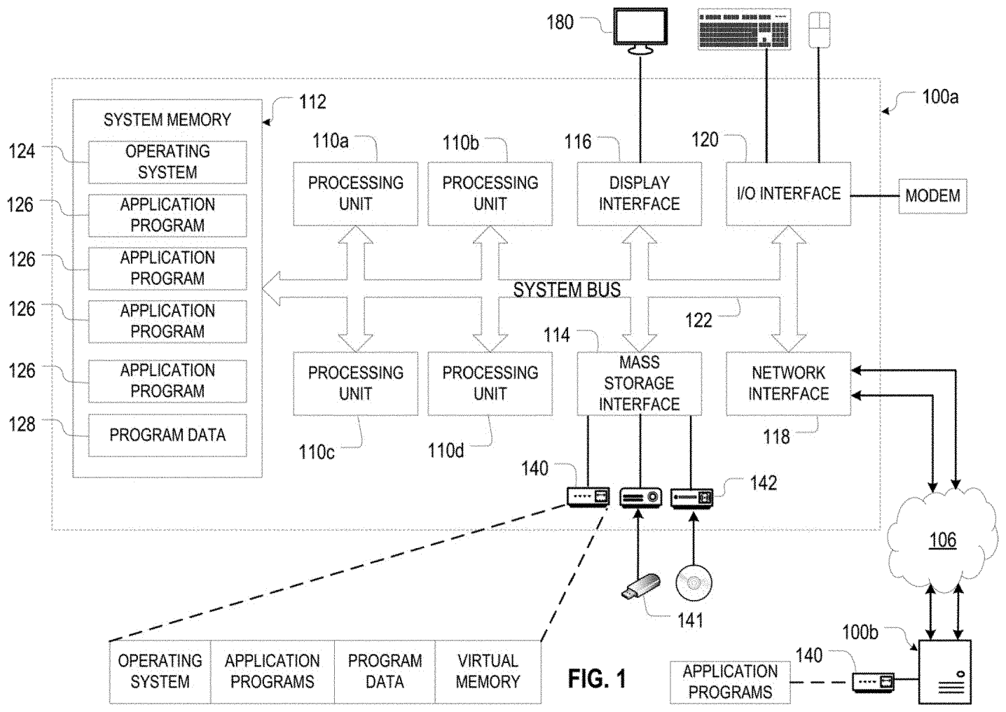

FIG. 1 illustrates one embodiment of a data processing system (DPS) 100a, 100b (herein generically referred to as a DPS 100), consistent with some embodiments. FIG. 1 only depicts the representative major components of the DPS 100, and those individual components may have greater complexity than represented in FIG. 1. In some embodiments, the DPS 100 may be implemented as a personal computer; server computer; portable computer, such as a laptop or notebook computer, PDA (Personal Digital Assistant), tablet computer, or smartphone; processors embedded into larger devices, such as an automobile, airplane, teleconferencing system, appliance; smart devices; or any other appropriate type of electronic device. Moreover, components other than or in addition to those shown in FIG. 1 may be present, and that the number, type, and configuration of such components may vary.

The data processing system 100 in FIG. 1 may comprise a plurality of central processing units 110a-110d (generically, processor 110 or CPU 110) that may be connected to a main memory 112, a mass storage interface 114, a terminal/display interface 116, a network interface 118, and an input/output (“I/O”) interface 120 by a system bus 122. The mass storage interfaces 114 in this embodiment may connect the system bus 122 to one or more mass storage devices, such as a direct access storage device 140 or a readable/writable optical disk drive 142. The network interfaces 118 may allow the DPS 100a to communicate with other DPS 100b over the network 106. The main memory 112 may also contain an operating system 124, a plurality of application programs 126, and program data 128.

The DPS 100 embodiment in FIG. 1 may be a general-purpose computing device. In these embodiments, the processors 110 may be any device capable of executing program instructions stored in the main memory 112, and may themselves be constructed from one or more microprocessors and/or integrated circuits. In some embodiments, the DPS 100 may contain multiple processors and/or processing cores, as is typical of larger, more capable computer systems; however, in other embodiments, the computing systems 100 may only comprise a single processor system and/or a single processor designed to emulate a multiprocessor system. Further, the processor(s) 110 may be implemented using a number of heterogeneous data processing systems 100 in which a main processor 110 is present with secondary processors on a single chip. As another illustrative example, the processor(s) 110 may be a symmetric multiprocessor system containing multiple processors 110 of the same type

When the DPS 100 starts up, the associated processor(s) 110 may initially execute program instructions that make up the operating system 124. The operating system 124, in turn, may manage the physical and logical resources of the DPS 100. These resources may include the main memory 112, the mass storage interface 114, the terminal/display interface 116, the network interface 118, and the system bus 122. As with the processor(s) 110, some DPS 100 embodiments may utilize multiple system interfaces 114, 116, 118, 120, and buses 122, which in turn, may each include their own separate, fully programmed microprocessors.

Instructions for the operating system 124 and/or application programs 126 (generically, “program code,” “computer usable program code,” or “computer readable program code”) may be initially located in the mass storage devices, which are in communication with the processor(s) 110 through the system bus 122. The program code in the different embodiments may be embodied on different physical or tangible computer-readable media, such as the memory 112 or the mass storage devices. In the illustrative example in FIG. 1, the instructions may be stored in a functional form of persistent storage on the direct access storage device 140. These instructions may then be loaded into the main memory 112 for execution by the processor(s) 110. However, the program code may also be located in a functional form on the computer-readable media, such as the direct access storage device 140 or the readable/writable optical disk drive 142, that is selectively removable in some embodiments. It may be loaded onto or transferred to the DPS 100 for execution by the processor(s) 110.

With continuing reference to FIG. 1, the system bus 122 may be any device that facilitates communication between and among the processor(s) 110; the main memory 112; and the interface(s) 114, 116, 118, 120. Moreover, although the system bus 122 in this embodiment is a relatively simple, single bus structure that provides a direct communication path among the system bus 122, other bus structures are consistent with the present disclosure, including without limitation, point-to-point links in hierarchical, star or web configurations, multiple hierarchical buses, parallel and redundant paths, etc.

The main memory 112 and the mass storage devices 140 may work cooperatively to store the operating system 124, the application programs 126, and the program data 128. In some embodiments, the main memory 112 may be a random-access semiconductor memory device (“RAM”) capable of storing data and program instructions. Although FIG. 1 conceptually depicts that the main memory 112 as a single monolithic entity, the main memory 112 in some embodiments may be a more complex arrangement, such as a hierarchy of caches and other memory devices. For example, the main memory 112 may exist in multiple levels of caches, and these caches may be further divided by function, such that one cache holds instructions while another cache holds non-instruction data that is used by the processor(s) 110. The main memory 112 may be further distributed and associated with a different processor(s) 110 or sets of the processor(s) 110, as is known in any of various so-called non-uniform memory access (NUMA) computer architectures. Moreover, some embodiments may utilize virtual addressing mechanisms that allow the DPS 100 to behave as if it has access to a large, single storage entity instead of access to multiple, smaller storage entities (such as the main memory 112 and the mass storage device 140).

Although the operating system 124, the application programs 126, and the program data 128 are illustrated in FIG. 1 as being contained within the main memory 112 of DPS 100a, some or all of them may be physically located on a different computer system (e.g., DPS 100b) and may be accessed remotely, e.g., via the network 106, in some embodiments. Moreover, the operating system 124, the application programs 126, and the program data 128 are not necessarily all completely contained in the same physical DPS 100a at the same time, and may even reside in the physical or virtual memory of other DPS 100b.

The system interfaces 114, 116, 118, 120 in some embodiments may support communication with a variety of storage and I/O devices. The mass storage interface 114 may support the attachment of one or more mass storage devices 140, which may include rotating magnetic disk drive storage devices, solid-state storage devices (SSD) that uses integrated circuit assemblies as memory to store data persistently, typically using flash memory or a combination of the two. Additionally, the mass storage devices 140 may also comprise other devices and assemblies, including arrays of disk drives configured to appear as a single large storage device to a host (commonly called RAID arrays) and/or archival storage media, such as hard disk drives, tape (e.g., mini-DV), writeable compact disks (e.g., CD-R and CD-RW), digital versatile disks (e.g., DVD, DVD-R, DVD+R, DVD+RW, DVD-RAM), holography storage systems, blue laser disks, IBM Millipede devices, and the like.

The terminal/display interface 116 may be used to directly connect one or more display units 180 to the data processing system 100. These display units 180 may be non-intelligent (i.e., dumb) terminals, such as an LED monitor, or may themselves be fully programmable workstations that allow IT administrators and users to communicate with the DPS 100. Note, however, that while the display interface 116 may be provided to support communication with one or more displays 180, the computer systems 100 does not necessarily require a display 180 because all needed interaction with users and other processes may occur via the network 106.

The network 106 may be any suitable network or combination of networks and may support any appropriate protocol suitable for communication of data and/or code to/from multiple DPS 100. Accordingly, the network interfaces 118 may be any device that facilitates such communication, regardless of whether the network connection is made using present-day analog and/or digital techniques or via some networking mechanism of the future. Suitable networks 106 include, but are not limited to, networks implemented using one or more of the “Infiniband” or IEEE (Institute of Electrical and Electronics Engineers) 802.3x “Ethernet” specifications; cellular transmission networks; wireless networks implemented one of the IEEE 802.11x, IEEE 802.16, General Packet Radio Service (“GPRS”), FRS (Family Radio Service), or Bluetooth specifications; Ultra-Wide Band (“UWB”) technology, such as that described in FCC 02-48; or the like. Those skilled in the art will appreciate that many different network and transport protocols may be used to implement the network 106. The Transmission Control Protocol/Internet Protocol (“TCP/IP”) suite contains a suitable network and transport protocols.

### Cloud Computing

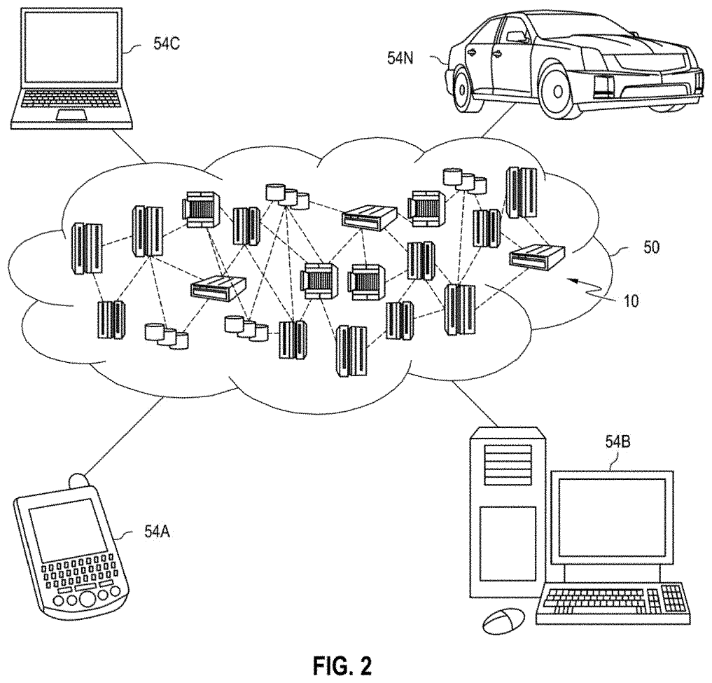

FIG. 2 illustrates one embodiment of a cloud environment suitable for an edge enabled scalable and dynamic transfer learning mechanism. It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:
On-demand self-service: a cloud consumer can unilaterally provision computing capabilities, such as server time and network storage, as needed automatically without requiring human interaction with the service's provider.
Broad network access: capabilities are available over a network and accessed through standard mechanisms that promote use by heterogeneous thin or thick client platforms (e.g., mobile phones, laptops, and PDAs).
Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).
Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.
Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:
Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.
Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.
Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:
Private cloud: the cloud infrastructure is operated solely for an organization. It may be managed by the organization or a third party and may exist on-premises or off-premises.
Community cloud: the cloud infrastructure is shared by several organizations and supports a specific community that has shared concerns (e.g., mission, security requirements, policy, and compliance considerations). It may be managed by the organizations or a third party and may exist on-premises or off-premises.
Public cloud: the cloud infrastructure is made available to the general public or a large industry group and is owned by an organization selling cloud services.
Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Referring now to FIG. 2, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

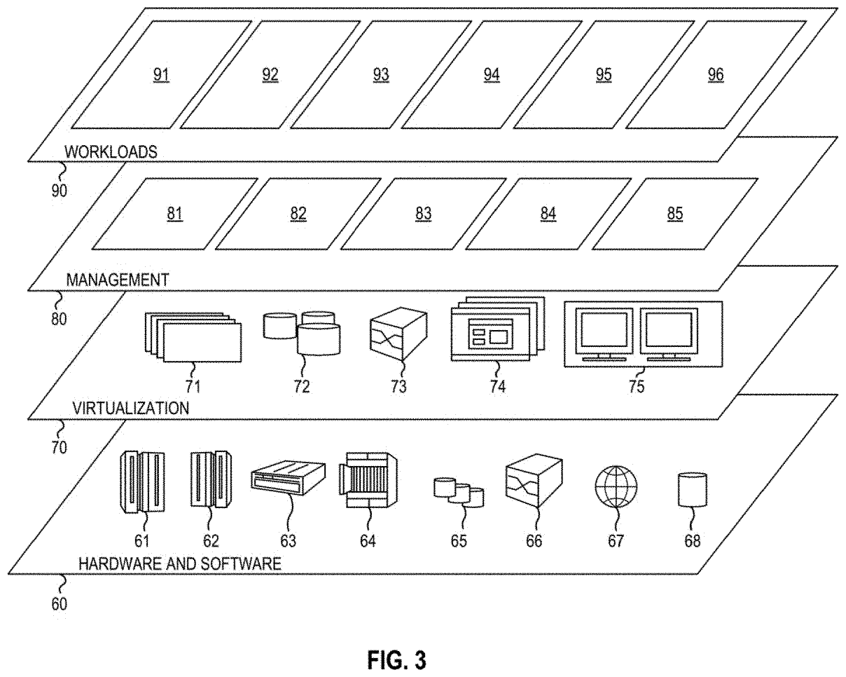

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; application processor 96; and a blockchain node 98.

### Supply Chain Optimizer

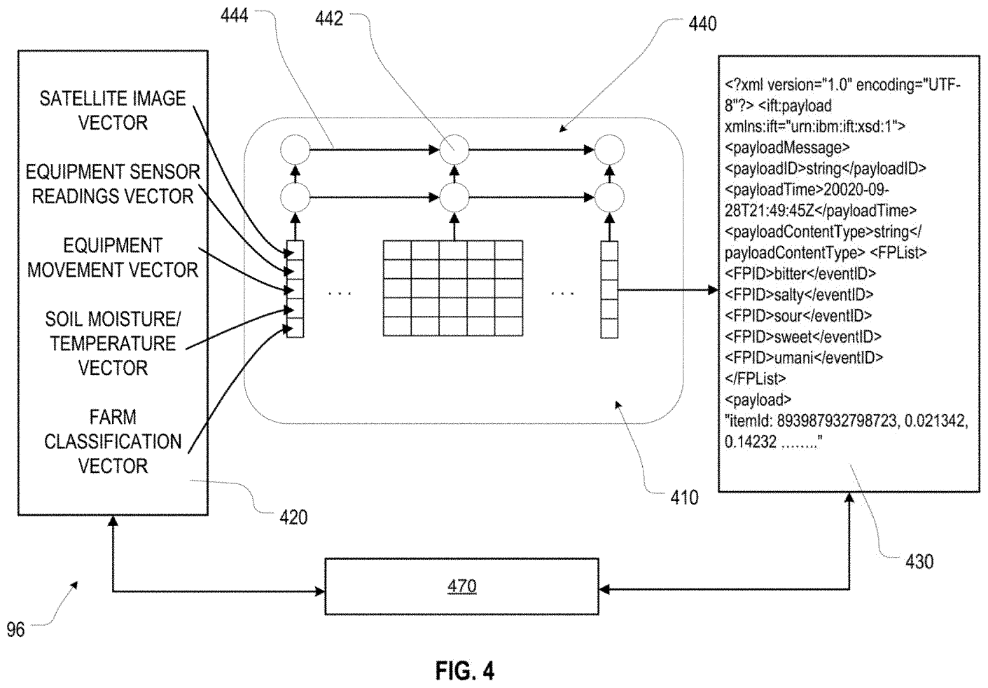

FIG. 4 is a system diagram for the supply chain optimizer 400, which may be structured as, e.g., the application processor 96, consistent with some embodiments. The system supply chain optimizer 400 embodiment in FIG. 4 may receive as input a plurality of feature vectors 420 containing time stamped events from a plurality of different data sources (e.g., sensors, satellites, manual logs, etc.), and may generate output 430 in the form of individualized flavor profile (“FP”) function coefficients representing the predicted taste and smell for a particular date for each of a plurality of particular food items on a particular day. The supply chain optimizer 400 may comprise an AI engine 440 executing on a DPS 100a within a cloud computing environment 50. The supply chain optimizer 400 may receive and send data vectors to a blockchain 470 executing on the blockchain node 98.

For illustrative purposes, the AI engine 440 will be described with reference to a LSTM class machine learning model (“LSTM model”). LSTM models may be desirable because they can remember values over arbitrary time intervals. This, in turn, may allow for classifying events in input time series data for particular entities, as there may be lags of unknown duration between important events in the time series. However, other types of ML models are consistent with the disclosure, as are algorithmic models.

In some embodiments, the LSTM model may comprise a plurality of artificial cells 442 interconnected through connection points called gates 444. Each cell 442 in some embodiments may comprise an input gate, an output gate, and a forget gate. The cells 442 may be interconnected such that the output gate 444 of one cell 442 is the input gate of another cell 442.

The cells 442 in some embodiments may be the sub-entity that remembers the values over the arbitrary time intervals, and the gates 444 may be the sub-entity that regulates the flow of information into and out of the cell. Each gate 444 in the LSTM model may further encode a strength of a relationship in the connection between the output of one cell 442 and the input of another cell 442. The output of each cell 442, in turn, may be determined by the aggregate input(s) received from other cells 442 that are connected to it via gates 444, and thus by the outputs of these “upstream” connected cells 442 and the strength of the connections as determined by numeric weights on the gates 444.

LSTM models may be trained to solve a specific problem (e.g., identification of significant events) by adjusting the weights of the gates 444 such that a particular class of inputs produces the desired output. This weight adjustment procedure in these embodiments is known as “learning.” Ideally, these adjustments lead to a pattern of weights that, during the learning process, converge toward an optimal solution for the given problem based on some cost function. In some embodiments, the cells 442 may be organized into layers. The layer that receives external input data in the form of the feature vectors 420 is the input layer. The layer that produces the ultimate result 430 is the output layer. Some embodiments include a large number of hidden layers between the input and output layers, commonly hundreds of such hidden layers.

During an initial configuration phase, the supply chain optimizer 400 in some embodiments may receive a training corpus. The training corpus may contain a set of training vectors from a plurality of different farms, transportation companies, processors, and retailers in a plurality of different geographic locations that are growing a plurality of different food items in a plurality of different locations in a plurality of different years. The training corpus may further contain labels identifying the resulting taste and smell profiles of the resulting food items. These labels may have been subjectively categorized by a consumer or agriculture expert. Additionally or alternatively, these labels may have been directly measured using chemical analysis instruments, such as an electronic nose optimized to mimic human olfactory functions.

During a subsequent execution phase, the supply chain optimizer 400 may receive as input a new corpus (i.e., unlabeled) describing a particular farm, processor, shipper, etc. The supply chain optimizer 400 may use the new corpus to calculate as output 430 a set of coefficients that allow for calculation of a predicted individual flavor profile for that particular agricultural item for a particular date. That is, the flavor profile may be a function of (i.e., dependent on) a date input in some embodiments. Next, a user can place order for product having a particular taste profile to be consumed on a particular date, or range of dates. In response, some embodiments may use the trained machine learning model to identify an appropriate supply chain route, growth stage of harvesting, duration of transportation and types of preservation applied, so that required flavor and taste (same or similar) will be found on the food item on the desired date.

### Training Phase

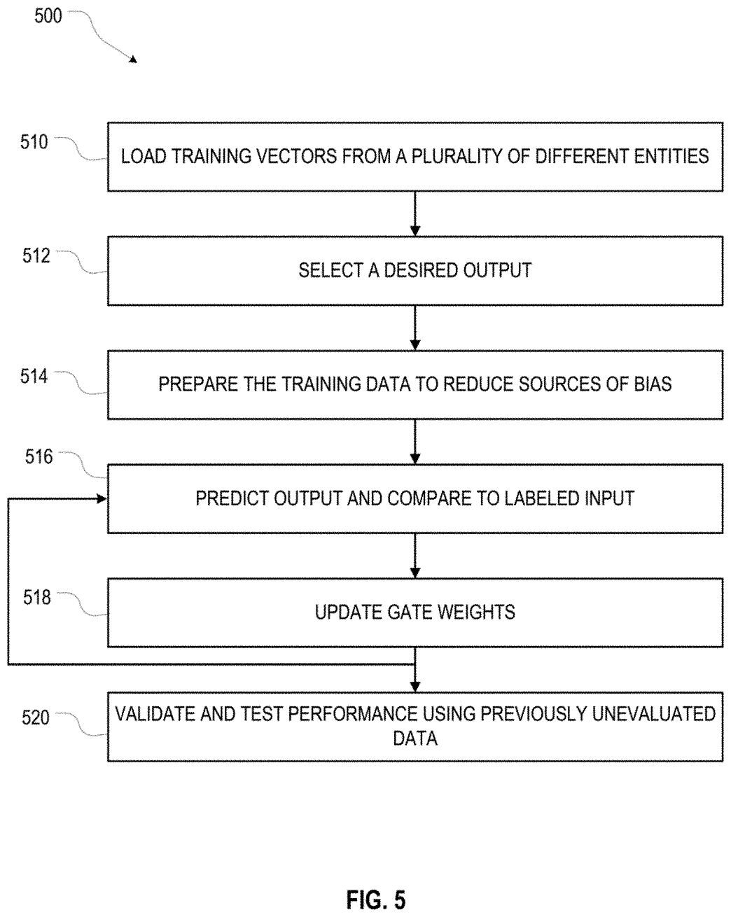

FIG. 5 is a flow chart illustrating one method of training 500 the supply chain optimizer 400, consistent with some embodiments. A user may begin by loading training vectors from a plurality of different entities in the agricultural ecosystem at operation 510. For example, for significance identification with respect to a farm, the training vectors may include static information such as: ownership information for a field, location information about a sub-field, physical information about a sub-field (e.g., elevation, slope), etc. The labeled training vectors for a farm may also include a time series of events that occurred at that farm, e.g., the particular seed type planted, daily weather, fertilization days and types, irrigation days and amounts, insecticide application dates and types, herbicide application dates and types, pruning events, and harvesting events (e.g., yield metrics, quality metrics, etc.) The training vectors may further include movement of particular machines (e.g., a planter, a truck) through the particular entity (e.g., a sub-field, a delivery route) together with time-stamped or geo-stamped outputs from various sensors on that equipment. The training vectors may further include remotely sensed information, such as images from a satellite or drone. For a processor, the training vectors may include information about where its various inputs were sourced (e.g., the field or sub-field), the specific trucks used to move the inputs and their load histories (e.g., what they hauled before the current input), the specific machines used to process the input and their processing histories, time-stamped operational settings for those processing machines, when any serviceable parts on those machines were last replaced (e.g., cutting blades), etc. The training vectors in some embodiments may further include manually entered labels identifying the resulting flavor profile on a particular date. Additionally or alternatively, the labels may include flavor/smell profiles measured by chemical analysis instruments.

At operation 512, the user may select a desired output (e.g., a flavor profile for that particular food item on a particular date). At operation 514, the training data may be prepared to reduce sources of bias, typically including de-duplication, normalization, and order randomization. At operation 516, the initial weights of the gates 444 for the ML model may be randomized. At operation 518, the ML model may be used to predict an output using set of input data vectors, and that prediction is compared to the labeled data. The error (e.g., the difference between the predicted value and the labeled data) is then used at operation 520 to update the gate weights. Operations 515-518 may be repeated, with each iteration updating the weights, until the training data is exhausted, or the ML model reaches an acceptable level of accuracy and/or precision. At operation 520, the resulting model may optionally be compared to previously unevaluated data to validate and test its performance.

### Execution Phase

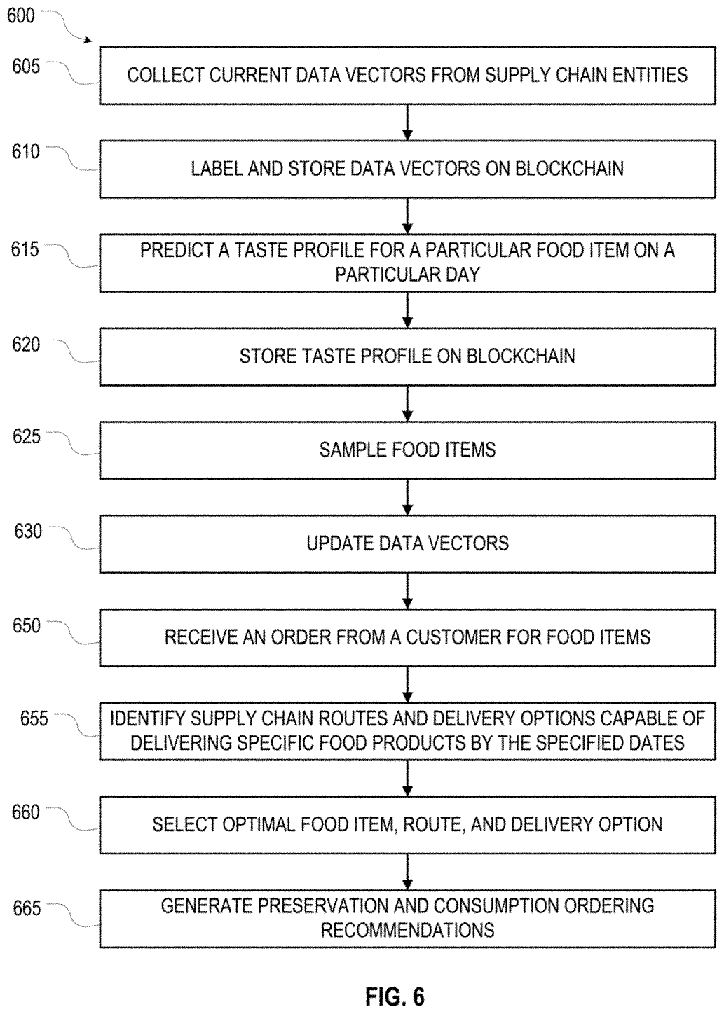

FIG. 6 is a flow chart of an execution phase 600 of the supply chain optimizer 400, consistent with some embodiments. At operation 605, the supply chain optimizer 400 may begin receiving current data vectors from a plurality of different entities in the agricultural ecosystem. Like the training vectors discussed above, these current data vectors may include different types of sensors to track various parameters during the entire growing period of the agricultural product in any cultivation field, during the shipping process, during any processing, and during wholesale and retail operations. These vectors may include, without limitation: a) weather parameters; b) soil parameters; c) types of support provided during the growth cycle (e.g. watering, organic, etc.); d) lifecycle stage of harvesting (e.g., while green vs. ripe); e) types of preservation used; f) mode of transportation (e.g., frozen, refrigerated, etc.); g) types of tree or plant; h) chemical analysis or taste and smell, etc. Additionally, a growing period may be defined by an agricultural team, such as from soil preparation to harvesting or from previous cultivated crops to harvesting. Along with the weather parameters, some embodiments may also collect various other parameters, such as soil parameters, how the cultivation is done, like watering etc. Some embodiments may also perform chemical test sampling from the growing crops in different stages. The chemical test from the growing crops may include direct measurements of various chemical compositions, such as a current taste profile generated by an electronic nose instrument. These different data feeds may be labeled and stored to the blockchain 470 at operation 610. Additionally or alternatively, the supply chain entities may label and store the data vectors directly onto the blockchain 470, and the supply chain optimizer 400 may download the vectors from the blockchain 470.

The gathered data may be analyzed using the trained AI engine 440, and accordingly, a knowledge corpus and trained LSTM model may be created. Based on the trained LSTM model, the supply chain optimizer 400 may calculate a number of taste coefficients that can be used to predict a taste profile for each of the individual food items (e.g., individual fruit and vegetables) in the supply chain at operation 615. These taste profiles may be specific to a particular date, or may be a function of time/date. The supply chain optimizer 400 may then upload the predicted flavor profile(s) to a record associated with that food item to the blockchain 470 at operation 620. This flavor profile may include a temporal factor such that the predicted flavor profile of food items will change depending on where and when it currently sits in the overall supply chain. These embodiments may be desirable because they can account for changing taste profiles, e.g., as the food item ripens.

At operation 625, the supply chain optimizer 400 may periodically sample the food items and update the chemical test results at different points of time. These updated data vectors may be stored on the blockchain 470 at operation 630 and used by the AI engine 440 to better model how the taste and smell is changing over time in response to different conditions.

At operation 650, the supply chain optimizer 400 may receive an order from a customer for food items. The order may specify a particular desired flavor profile. In some embodiments, operation 650 comprise a “similar to” function where the customer indicates they liked a particular, previously consumed, food item and would like more that taste like it did. In some embodiments, this may comprise utilizing an individualized food preference profile, in which the customer indicates they liked or disliked a series of previously consumed food items, and the system trying to match future food items to that preference profile. In some embodiments, this may include the user directly specifying the taste profile as series of metrics (e.g., scores indicative of the desired bitter, salty, sour, sweet, and umami characteristics of the product). At operation 610, the supply chain optimizer 400 may also receive a desired consumption date and/or date range from the customer.

In response, the supply chain optimizer 400 may match the received order with one or more compatible food items the product at operations 655-660. This may include identifying one or more supply chain routes and delivery options capable of delivering specific food products by the specified dates at operation 655; and then, based on the specified taste and flavor, the duration of consumption, and a cost estimate for each path, select the combination of specific food item, specific supply chain route, and specific delivery option that most nearly matches the desired flavor profile at operation 660. This, in turn, may include predicting what will be the taste profile of the specific food item on the specified consumption date given the transportation types and modes of preservation in the corresponding routes and delivery options. In some embodiments, this may also include calculating what should be maturity state(s) of the food item(s) be at delivery so that customer can get the desired flavor profile on the consumption date(s).

Optionally, some embodiments may generate recommendations about how to preserve the food items, and what sequence the products are to be consumed to get same/similar smell and taste of the food, to the user at operation 655. This may include recommendations to speed the ripening of specific food items in the order and recommendations to slow the ripening of specific food items in the order.

### Blockchain Architecture

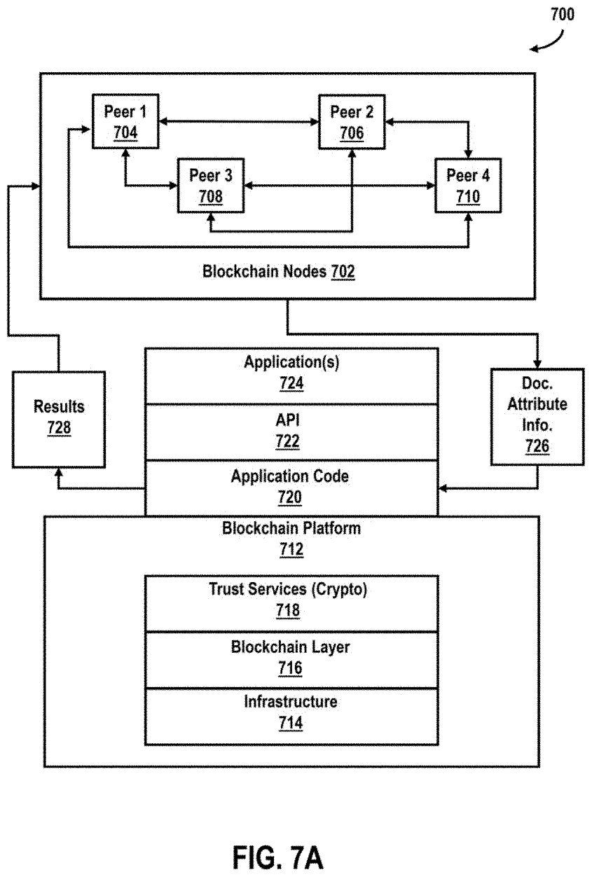

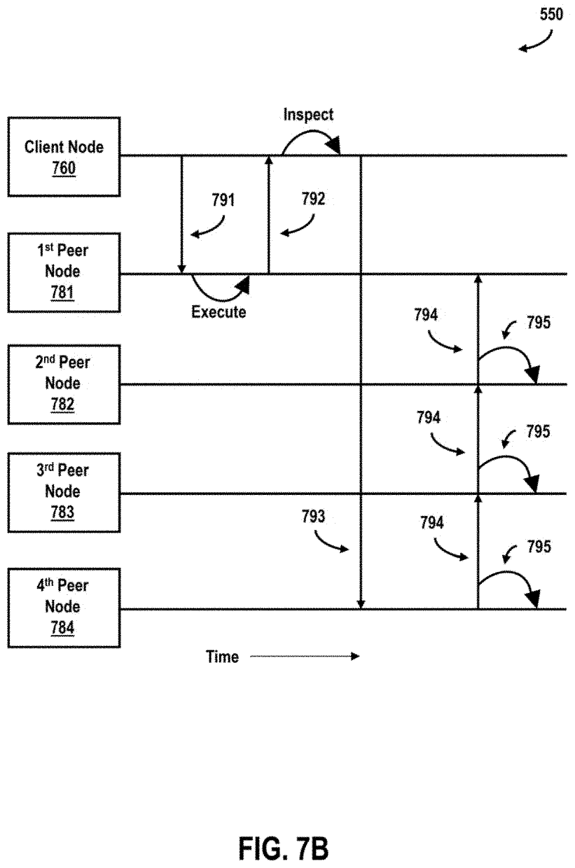

FIG. 7A illustrates a blockchain architecture configuration 700, consistent with some embodiments. The blockchain architecture 700 in these embodiments may include certain blockchain elements, for example, a group of blockchain nodes 702. The group of blockchain nodes 702, in turn, may include one or more member nodes 704-710 (these four nodes are depicted by example only). These member nodes 704-710 may participate in a number of activities, such as blockchain transaction addition and validation process (consensus). One or more of the member nodes 704-710 may endorse transactions based on endorsement policy and may provide an ordering service for all blockchain nodes in the architecture 700. A member node 704-710 may initiate a blockchain authentication and seek to write to a blockchain immutable ledger stored in blockchain layer 716, a copy of which may also be stored on the underpinning physical infrastructure 714.

The blockchain architecture 700 in some embodiments may include one or more applications 724, which are linked to application programming interfaces (APIs) 722 to access and execute stored program/application code 720 (e.g., chaincode, smart contracts, etc.). The stored program/application code 720, in turn, can be created according to a customized configuration sought by participants and can maintain its own state, control their own assets, and receive external information.

The stored program/application code 720 can be deployed as a transaction and installed, via appending to the distributed ledger, on all blockchain nodes 704-710.

A blockchain base or platform 712 may include various layers of blockchain data, services (e.g., cryptographic trust services, virtual execution environment, etc.), and underpinning physical computer infrastructure that may be used to receive and store new transactions and provide access to auditors which are seeking to access data entries. A blockchain layer 716 may expose an interface that provides access to the virtual execution environment necessary to process the program code and engage a physical infrastructure 714. Cryptographic trust services 718 may be used to verify transactions such as asset exchange transactions and keep information private.

The blockchain architecture configuration of FIG. 7A may process and execute the program/application code 720 via one or more interfaces exposed, and services provided, by the blockchain platform 712. The program/application code 720 may control blockchain assets. For example, the code 720 can store and transfer data, and may be executed by member nodes 704-710 in the form of a smart contract and associated chaincode with conditions or other code elements subject to its execution. As a non-limiting example, smart contracts may be created to execute reminders, updates, and/or other notifications subject to the changes, updates, etc. The smart contracts can themselves be used to identify rules associated with authorization and access requirements and usage of the ledger. For example, document attribute(s) information 726 may be processed by one or more processing entities (e.g., virtual machines) included in the blockchain layer 716. A result 728 may include a plurality of linked shared documents. The physical infrastructure 714 may be utilized to retrieve any of the data or information described herein.

In some embodiments, the smart contract may be created via a high-level application and programming language, and then written to a block in the blockchain. The smart contract may include executable code that is registered, stored, and/or replicated with a blockchain (e.g., distributed network of blockchain peers). A transaction is an execution of the smart contract code that can be performed in response to conditions associated with the smart contract being satisfied. The executing of the smart contract may trigger a trusted modification(s) to a state of a digital blockchain ledger. The modification(s) to the blockchain ledger caused by the smart contract execution may be automatically replicated throughout the distributed network of blockchain peers through one or more consensus protocols in some embodiments.

The smart contract may write data to the blockchain in the format of key-value pairs. In some embodiments, the smart contract code can also read the values stored in a blockchain and use them in application operations. The smart contract code in these embodiments can then write the output of various logic operations into the blockchain. The smart contract code, in some embodiments, may be used to create a temporary data structure in a virtual machine or other computing platforms. Data written to the blockchain in these embodiments may be public or may be encrypted and maintained as private. The temporary data that is used/generated by the smart contract may be held in memory by the supplied execution environment, and then may be deleted once the data needed for the blockchain is identified.

The chaincode in some embodiments may comprise a code interpretation of a smart contract, with additional features. In some embodiments, the chaincode may be implemented as program code deployed on a computing network, where it is executed and validated by chain validators together during a consensus process. The chaincode may receive a hash and may retrieve from the blockchain a hash associated with the data template created by the use of a previously stored feature extractor. If the hashes of the hash identifier and the hash created from the stored identifier template data match, then the chaincode may send an authorization key to the requested service. The chaincode may write to the blockchain data associated with the cryptographic details.

FIG. 7B illustrates an example of a blockchain transactional flow 750 between nodes of the blockchain in accordance with some embodiments. The transaction flow in these embodiments may include a transaction proposal 791 sent by an application client node 760 to an endorsing peer node 781. The endorsing peer 781 may verify the client signature and execute a chaincode function to initiate the transaction. The output may include the chaincode results, a set of key/value versions that were read in the chaincode (read set), and the set of keys/values that were written in chaincode (write set). The proposal response 792 may then be sent back to the client 760, along with an endorsement signature, if approved.

In response, the client 760 may assemble the endorsements into a transaction payload 793 and broadcasts it to an ordering service node 784. The ordering service node 784 may then deliver ordered transactions as blocks to all peers 781-783 on a channel. Before committal to the blockchain, each peer 781-783 may validate the transaction. For example, the peers in some embodiments may check the endorsement policy to ensure that the correct allotment of the specified peers have signed the results and authenticated the signatures against the transaction payload 793.

With continuing reference to FIG. 7B, the client node 760 in some embodiments may initiate the transaction 791 by constructing and sending a request to the peer node 781, which may act an endorser. The client 760 may include an application leveraging a supported software development kit (SDK), which may utilize an available API to generate a transaction proposal. The transaction proposal, in turn, may be a request to invoke a chaincode function so that data can be read and/or written to the distributed ledger (i.e., write new key value pairs for the assets). The SDK may serve as a shim to package the transaction proposal into a properly architected format (e.g., protocol buffer over a remote procedure call (RPC)) and take the client's cryptographic credentials to produce a unique signature for the transaction proposal.

In response, the endorsing peer node 781 may verify: (a) that the transaction proposal is well-formed; (b) the transaction has not been submitted already in the past (replay-attack protection); (c) the signature is valid; and (d) that the submitter (client 760, in this example embodiment) is properly authorized to perform the proposed operation on that channel. The endorsing peer node 781 may take the transaction proposal inputs as arguments to the invoked chaincode function. The chaincode may then be executed against a current state database to produce transaction results, including a response value, read set, and write set. In some embodiments, no updates are made to the ledger at this point. Instead, the set of values, along with the endorsing peer node's 781 signature, may be passed back as a proposal response 792 to the SDK of the client 760, which parses the payload for the application to consume.

In response, the application of the client 760 may inspect/verify the endorsing peers' signatures and may compare the proposal responses to determine if the proposal response is the same. If the chaincode only queried the ledger, the application may inspect the query response and would typically not submit the transaction to the ordering service 784. If the client application intends to submit the transaction to the ordering service 784 to update the ledger, the application may determine if the specified endorsement policy has been fulfilled before submitting (i.e., did all peer nodes necessary for the transaction endorse the transaction). Here, the client may include only one of a multiple parties to the transaction. In this case, each client may have their own endorsing node, and each endorsing node will need to endorse the transaction. The architecture is such that even if an application selects not to inspect responses or otherwise forwards an unendorsed transaction, the endorsement policy will still be enforced by peers and upheld at the commit validation phase.

After a successful inspection, in operation 793, the client 760 may assemble endorsements into a transaction and may broadcast the transaction proposal and response within a transaction message to the ordering service 784. The transaction may contain the read/write sets, the endorsing peers' signatures, and a channel ID. The ordering service 784 does not need to inspect the entire content of a transaction in order to perform its operation; instead the ordering service 784 may simply receive transactions from all channels in the network, order them chronologically by channel, and create blocks of transactions per channel.

The blocks of the transaction may be delivered from the ordering service 784 to all peer nodes 781-783 on the channel. The transactions 794 within the block may be validated to ensure any endorsement policy is fulfilled and to ensure that there have been no changes to ledger state for read set variables since the read set was generated by the transaction execution. Transactions in the block may be tagged as being valid or invalid. Furthermore, in operation 795, each peer node 781-783 may append the block to the channel's chain, and for each valid transaction, the write sets are committed to the current state database. An event may be emitted to notify the client application that the transaction (invocation) has been immutably appended to the chain, as well as to notify whether the transaction was validated or invalidated.

### Permissioned Blockchains

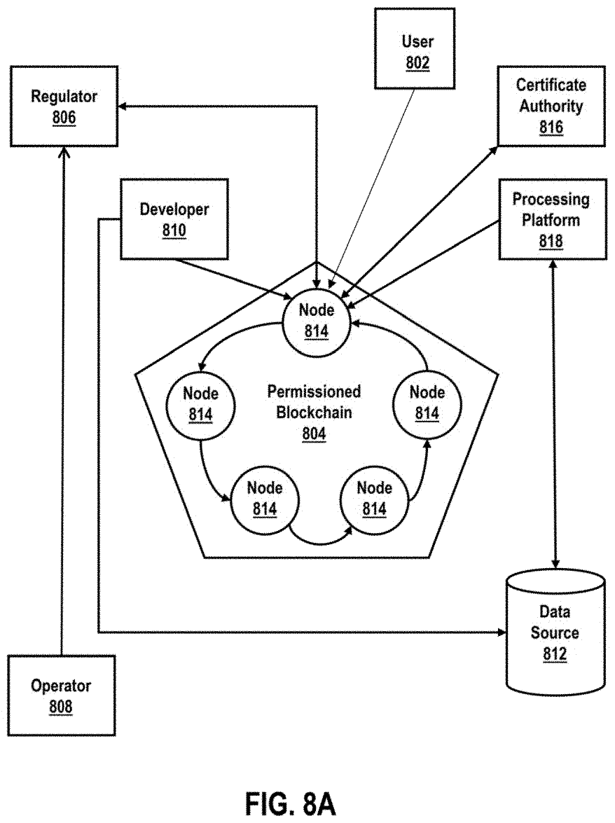

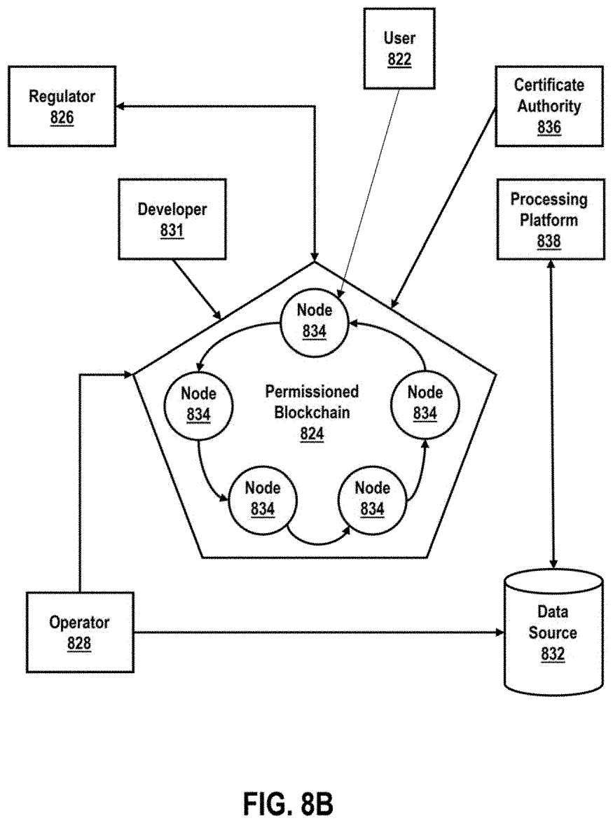

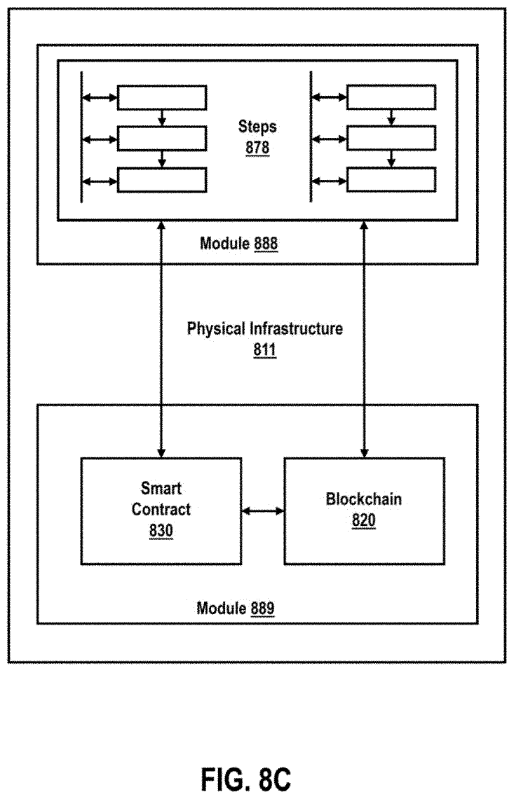

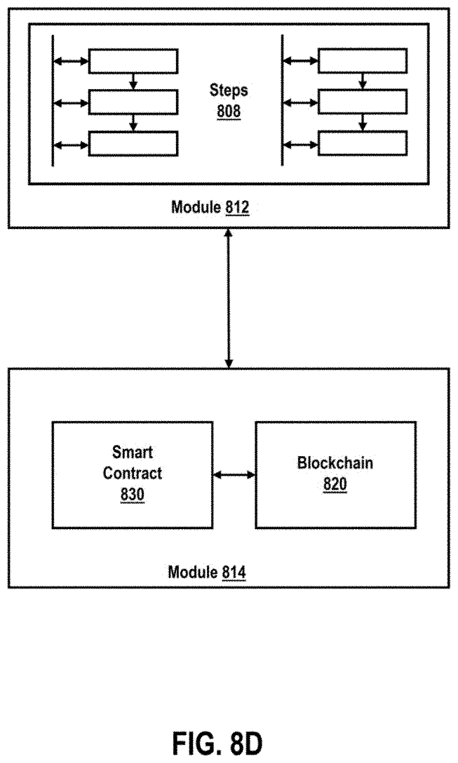

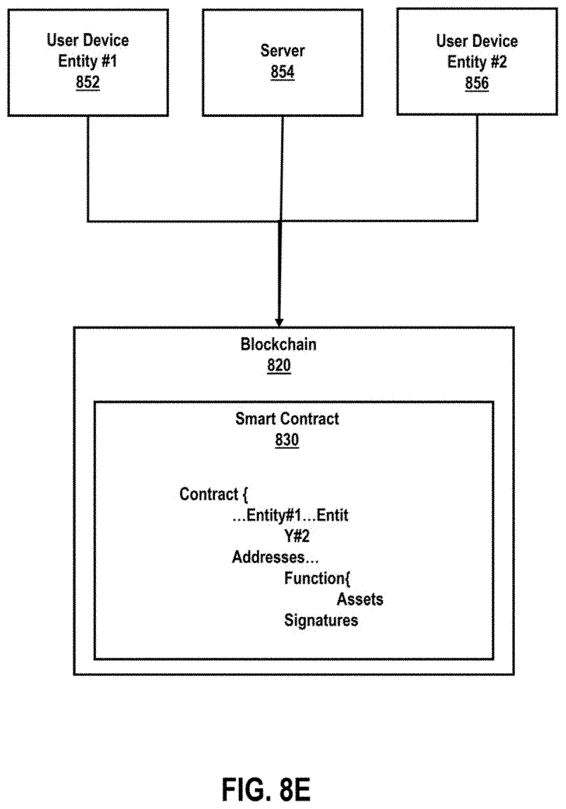

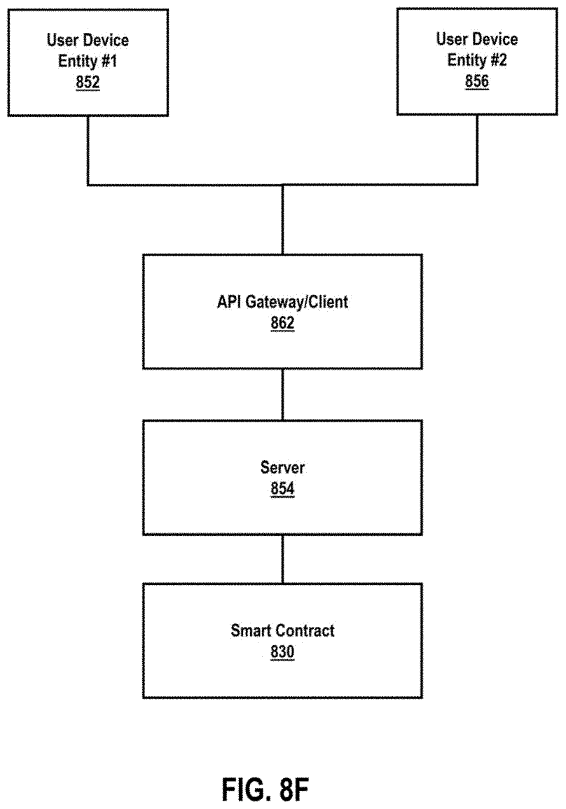

FIG. 8A illustrates an example of a permissioned blockchain network, which features a distributed, decentralized peer-to-peer architecture, consistent with some embodiments. In this example, a blockchain user 802 may initiate a transaction to the permissioned blockchain 804. In this example, the transaction may be a deploy, invoke, or query, and may be issued through a client-side application leveraging an SDK, directly through an API, etc. Networks may provide access to a regulator 806, such as an auditor. A blockchain network operator 808 manages member permissions, such as enrolling the regulator 806 as an “auditor” and the blockchain user 802 as a “client.” An auditor may be restricted only to querying the ledger, whereas a client may be authorized to deploy, invoke, and query certain types of chaincode.

A blockchain developer 810 can write chaincode and client-side applications in some embodiments. The blockchain developer 810 in these embodiments may deploy chaincode directly to the network through an interface. To include credentials from a traditional data source 812 in chaincode, the developer 810 may use an out-of-band connection to access the data. In this example, the blockchain user 802 may connect to the permissioned blockchain 804 through a peer node 814. Before proceeding with any transactions, the peer node 814 may retrieve the user's enrollment and transaction certificates from a certificate authority 816, which manages user roles and permissions. In some embodiments, blockchain users must possess these digital certificates in order to transact on the permissioned blockchain 804. In other embodiments, blockchain users may be authenticated using other techniques, such as via distributed chains of trust. Meanwhile, a user attempting to utilize chaincode may be required to verify their credentials on the traditional data source 812. Chaincode may use an out-of-band connection to this data through a traditional processing platform 818 to confirm the user's authorization.

FIG. 8B illustrates another example of a permissioned blockchain network, which features a distributed, decentralized peer-to-peer architecture, consistent with some embodiments. In this example, a blockchain user 822 may submit a transaction to the permissioned blockchain 824. In this example, the transaction can be a deploy, invoke, or query, and may be issued through a client-side application leveraging an SDK, directly through an API, etc. Networks may provide access to a regulator 826, such as an auditor. A blockchain network operator 828 manages member permissions, such as enrolling the regulator 826 as an “auditor” and the blockchain user 822 as a “client.” An auditor could be restricted only to querying the ledger, whereas a client could be authorized to deploy, invoke, and query certain types of chaincode.

A blockchain developer 831 in these embodiments may write chaincode and client-side applications. The blockchain developer 831 may deploy chaincode directly to the network through an interface. To include credentials from a traditional data source 832 in chaincode, the developer 831 may use an out-of-band connection to access the data. In this example, the blockchain user 822 connects to the network through a peer node 834. Before proceeding with any transactions, the peer node 834 retrieves the user's enrollment and transaction certificates from the certificate authority 836. In some embodiments, blockchain users must possess these digital certificates in order to transact on the permissioned blockchain 824. In other embodiments, blockchain users may be authenticated using other techniques, such as via distributed chains of trust. Meanwhile, a user attempting to utilize chaincode may be required to verify their credentials on the traditional data source 832. Chaincode can use an out-of-band connection to this data through a traditional processing platform 838 to confirm the user's authorization.

FIG. 8C illustrates an example system that includes a physical infrastructure 811 configured to perform various operations, consistent with some embodiments. Referring to FIG. 6C, the physical infrastructure 811 includes a module 888 and a module 889. The module 819 includes a blockchain 820 and a smart contract 830 (which may reside on the blockchain 820) that may execute any of the operational steps 878 (in module 812) included in any of the example embodiments. The steps/operations 878 may include one or more of the embodiments described or depicted and may represent output or written information that is written or read from one or more smart contracts 830 and/or blockchains 820. The physical infrastructure 811, the module 888, and the module 889 may include one or more computers, servers, processors, memories, and/or wireless communication devices. Further, the module 888 and the module 889 may be the same module.

FIG. 8D illustrates another example system configured to perform various operations, consistent with some embodiments. Referring to FIG. 8D, the system includes a module 812 and a module 814. The module 814 includes a blockchain 820 and a smart contract 830 (which may reside on the blockchain 820) that may execute any of the operational steps 878 (in module 812) included in any of the example embodiments. The steps/operations 878 may include one or more of the embodiments described or depicted and may represent output or written information that is written or read from one or more smart contracts 830 and/or blockchains 820. The physical module 812 and the module 814 may include one or more computers, servers, processors, memories, and/or wireless communication devices. Further, the module 812 and the module 814 may be the same module.

FIG. 8E illustrates an example system configured to utilize a smart contract configuration among contracting parties and a mediating server configured to enforce the smart contract terms on the blockchain 820, consistent with some embodiments. Referring to FIG. 8E, the configuration may represent a communication session, an asset transfer session, or a process or procedure that is driven by a smart contract 830, which explicitly identifies one or more user devices 852 and/or 856. The execution, operations, and results of the smart contract execution may be managed by a server 854. Content of the smart contract 830 may require digital signatures by one or more of the entities 852 and 856, which are parties to the smart contract transaction. The results of the smart contract execution may be written to a blockchain 820 as a blockchain transaction. The smart contract 830 resides on the blockchain 820, which may reside on one or more computers, servers, processors, memories, and/or wireless communication devices.

FIG. 8F illustrates a system 860, including a blockchain, consistent with some embodiments. Referring to the example of FIG. 8D, an application programming interface (API) gateway 862 provides a common interface for accessing blockchain logic (e.g., smart contract 830 or other chaincode) and data (e.g., distributed ledger, etc.). In this example, the API gateway 862 is a common interface for performing transactions (invoke, queries, etc.) on the blockchain by connecting one or more entities 852 and 856 to a blockchain peer (i.e., server 854). Here, the server 854 is a blockchain network peer component that holds a copy of the world state and a distributed ledger allowing clients 852 and 856 to query data on the world stage as well as submit transactions into the blockchain network where depending on the smart contract 830 and endorsement policy, endorsing peers will run the smart contracts 830.

### Block Processing

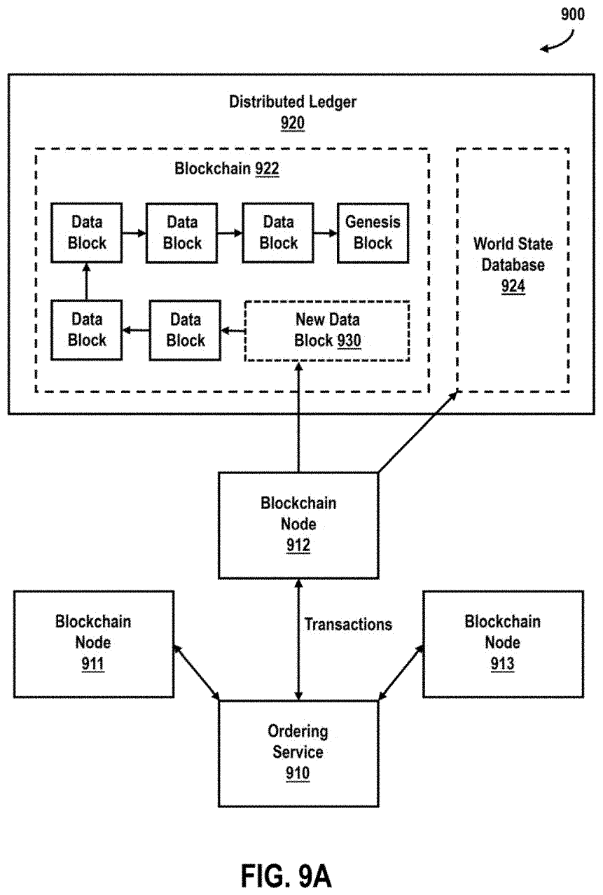

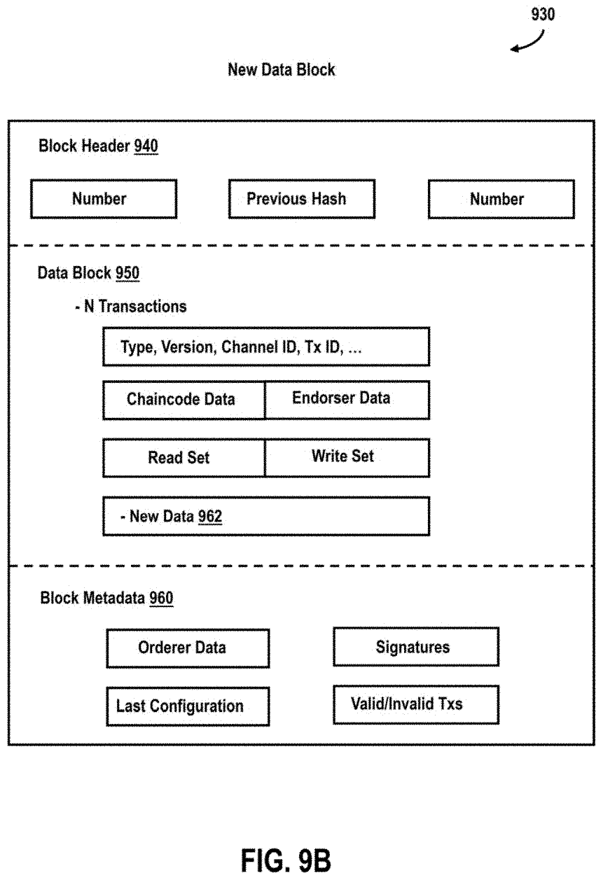

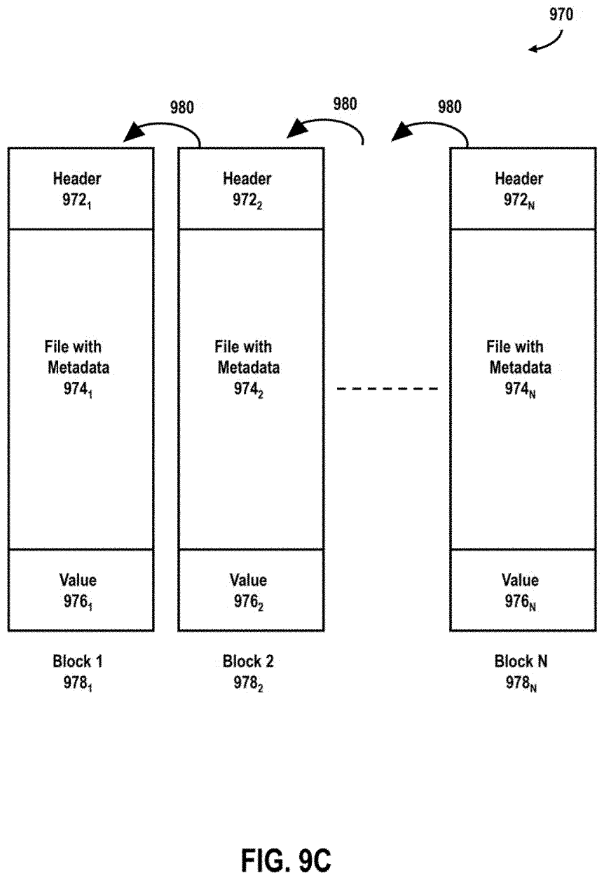

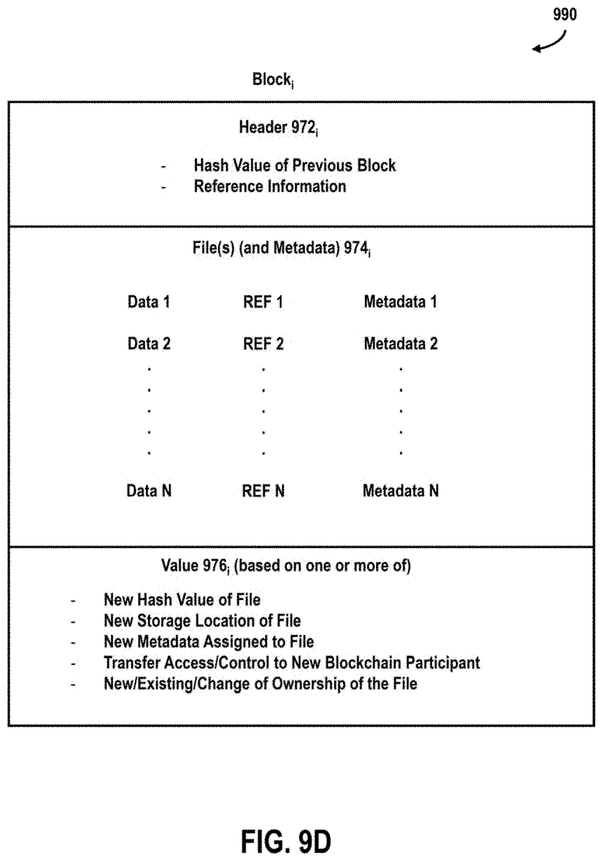

FIG. 9A illustrates a process 900 of a new data block 930 being added to a distributed ledger 920, consistent with some embodiments, and FIG. 7B illustrates contents of a new data block 930 for blockchain, consistent with some embodiments. The new data block 930 may contain document linking data.

Referring to FIG. 9A, clients (not shown) may submit transactions to blockchain nodes 911, 912, and/or 913. Clients may be instructions received from any source to enact activity on the blockchain 922. As an example, clients may be applications that act on behalf of a requester, such as a device, person, or entity to propose transactions for the blockchain. The plurality of blockchain peers (e.g., blockchain nodes 911, 912, and 913) may maintain a state of the blockchain network and a copy of the distributed ledger 920. Different types of blockchain nodes/peers may be present in the blockchain network including endorsing peers which simulate and endorse transactions proposed by clients and committing peers which verify endorsements, validate transactions, and commit transactions to the distributed ledger 920. In some embodiments, the blockchain nodes 911, 912, and 913 may perform the role of endorser node, committer node, or both.

The distributed ledger 920 may include a blockchain which stores immutable, sequenced records in blocks, and a state database 924 (current world state) maintaining a current state of the blockchain 922. One distributed ledger 920 may exist per channel and each peer maintains its own copy of the distributed ledger 920 for each channel of which they are a member. The blockchain 922 may be a transaction log, structured as hash-linked blocks where each block contains a sequence of N transactions. Blocks may include various components such as shown in FIG. 9B. The linking of the blocks (shown by arrows in FIG. 9A) may be generated by adding a hash of a prior block's header within a block header of a current block. In this way, all transactions on the blockchain 922 may be sequenced and cryptographically linked together preventing tampering with blockchain data without breaking the hash links. Furthermore, because of the links, the latest block in the blockchain 922 represents every transaction that has come before it. The blockchain 922 may be stored on a peer file system (local or attached storage), which supports an append-only blockchain workload.

The current state of the blockchain 922 and the distributed ledger 920 may be stored in the state database 924. Here, the current state data represents the latest values for all keys ever included in the chain transaction log of the blockchain 922. Chaincode invocations execute transactions against the current state in the state database 924. To make these chaincode interactions more efficient, the latest values of all keys may be stored in the state database 924. The state database 924 may include an indexed view into the transaction log of the blockchain 922, it can therefore be regenerated from the chain at any time. The state database 924 may automatically get recovered (or generated if needed) upon peer startup, before transactions are accepted.

Endorsing nodes receive transactions from clients and endorse the transaction based on simulated results. Endorsing nodes hold smart contracts which simulate the transaction proposals. When an endorsing node endorses a transaction, the endorsing node creates a transaction endorsement, which is a signed response from the endorsing node to the client application indicating the endorsement of the simulated transaction. The method of endorsing a transaction depends on an endorsement policy that may be specified within chaincode. An example of an endorsement policy is “the majority of endorsing peers must endorse the transaction.” Different channels may have different endorsement policies. Endorsed transactions are forward by the client application to ordering service 910.

The ordering service 910 accepts endorsed transactions, orders them into a block, and delivers the blocks to the committing peers. For example, the ordering service 910 may initiate a new block when a threshold of transactions has been reached, a timer times out, or another condition. In the example of FIG. 9A, blockchain node 912 is a committing peer that has received a new data new data block 930 for storage on blockchain 922. The first block in the blockchain may be referred to as a genesis block, which includes information about the blockchain, its members, the data stored therein, etc.

The ordering service 910 may be made up of a cluster of ordering nodes. The ordering service 910 in some embodiments may not process transactions, smart contracts, or maintain the shared ledger. Rather, the ordering service 910 in these embodiments may accept the endorsed transactions and specify the order in which those transactions are committed to the distributed ledger 920. The architecture of the blockchain network may be designed such that the specific implementation of “ordering” (e.g., Solo, Kafka, BFT, etc.) becomes a pluggable component.

Transactions in some embodiments may be written to the distributed ledger 920 in a consistent order. The order of transactions in these embodiments may be established to ensure that the updates to the state database 924 are valid when they are committed to the network. Unlike a cryptocurrency blockchain system (e.g., Bitcoin, etc.), where ordering occurs through the solving of a cryptographic puzzle, or mining, in this example the parties of the distributed ledger 920 may choose the ordering mechanism that best suits that network.

In some embodiments, when the ordering service 910 initializes a new data block 930, the new data block 930 may be broadcast to committing peers (e.g., blockchain nodes 911, 912, and 913). In response, each committing peer may validate the transaction within the new data block 930 by checking to make sure that the read set and the write set still match the current world state in the state database 924. Specifically, the committing peer may determine whether the read data that existed when the endorsers simulated the transaction is identical to the current world state in the state database 924. When the committing peer validates the transaction, the transaction may be written to the blockchain 922 on the distributed ledger 920, and the state database 924 may be updated with the write data from the read-write set. In some embodiments, if a transaction fails (e.g., if the committing peer finds that the read-write set does not match the current world state in the state database 924), the transaction ordered into a block may still be included in that block, but marked as invalid, and the state database 924 not updated.

Referring to FIG. 9B, a new data block 930 (also referred to as a data block) that is stored on the blockchain 922 of the distributed ledger 920 may include multiple data segments in some embodiments, such as a block header 940, block data 950, and block metadata 960. It should be appreciated that the various depicted blocks and their contents, such as new data block 930 and its contents, shown in FIG. 9B are merely examples and are not meant to limit the scope of the example embodiments. The new data block 930 may store transactional information of N transaction(s) (e.g., 1, 10, 100, 200, 1000, 2000, 3000, etc.) within the block data 950. The new data block 930 may also include a link to a previous block (e.g., on the blockchain 922 in FIG. 9A) within the block header 940. In particular, the block header 940 may include a hash of a previous block's header. The block header 940 may also include a unique block number, a hash of the block data 950 of the new data block 930, and the like. The block number of the new data block 930 may be unique and assigned in various orders, such as an incremental/sequential order starting from zero.

The block data 950 may store transactional information of each transaction that is recorded within the new data block 930. For example, the transaction data may include one or more of: a type of the transaction, a version, a timestamp, a channel ID of the distributed ledger 920, a transaction ID, an epoch, a payload visibility, a chaincode path (deploy tx), a chaincode name, a chaincode version, input (chaincode and functions), a client (creator) identify such as a public key and certificate, a signature of the client, identities of endorsers, endorser signatures, a proposal hash, chaincode events, response status, namespace, a read set (list of key and version read by the transaction, etc.), a write set (list of key and value, etc.), a start key, an end key, a list of keys, a Merkel tree query summary, and the like. The transaction data may be stored for each of the N transactions.

In some embodiments, the block data 950 may also store new data 962, which adds additional information to the hash-linked chain of blocks in the blockchain 922. The additional information may include one or more of the steps, features, processes and/or actions described or depicted herein. Accordingly, the new data 962 may be stored in an immutable log of blocks on the distributed ledger 920. Some of the benefits of storing such new data 962 are reflected in the various embodiments disclosed and depicted herein. Although in FIG. 9B the new data 962 is depicted in the block data 950, it could also be located in the block header 940 or the block metadata 960 in some embodiments. The new data 962 may also include a document composite key that is used for linking the documents within an organization.

The block metadata 960 may store multiple fields of metadata (e.g., as a byte array, etc.). Metadata fields may include: signature on block creation, a reference to a last configuration block, a transaction filter identifying valid and invalid transactions within the block, last offset persisted of an ordering service that ordered the block, and the like. The signature, the last configuration block, and the orderer metadata may be added by the ordering service 910. Meanwhile, a committer of the block (such as blockchain node 912) may add validity/invalidity information based on an endorsement policy, verification of read/write sets, and the like. The transaction filter may include a byte array of a size equal to the number of transactions in the block data 950 and a validation code identifying whether a transaction was valid/invalid.

FIG. 9C illustrates an embodiment of a blockchain 970 for digital content, consistent with some embodiments. The digital content may include one or more files and associated information. The files may include transaction data, media, images, video, audio, text, links, graphics, animations, web pages, documents, or other forms of digital content. The immutable, append-only aspects of some blockchain embodiments may be desirable to serve as a safeguard to protect the integrity, validity, and authenticity of the digital content, making it suitable use in legal proceedings where admissibility rules apply or other settings where evidence is taken in to consideration or where the presentation and use of digital information is otherwise of interest. In this case, the digital content may be referred to as digital evidence.

The blockchain in these embodiments may be formed in various ways. In one embodiment, the digital content may be included in and accessed from the blockchain itself. For example, each block of the blockchain may store a hash value of reference information (e.g., header, value, etc.) along the associated digital content. The hash value and associated digital content may then be encrypted together. Thus, the digital content of each block may be accessed by decrypting each block in the blockchain, and the hash value of each block may be used as a basis to reference a previous block. This may be illustrated as follows:

TABLE 1

| Block 1 | Block 2 | . . . | Block N |
|---|---|---|---|
| Hash Value 1 | Hash Value 2 | . . . | Hash Value N |
| Digital Content 1 | Digital Content 2 | . . . | Digital Content N |

In one embodiment, the digital content may not be included in the blockchain. For example, the blockchain may store the encrypted hashes of the content of each block without any of the digital content. The digital content may be stored in another storage area or memory address in association with the hash value of the original file. The other storage area may be the same storage device used to store the blockchain or may be a different storage area or even a separate relational database. The digital content of each block may be referenced or accessed by obtaining or querying the hash value of a block of interest and then looking up that has value in the storage area, which is stored in correspondence with the actual digital content. This operation may be performed, for example, a database gatekeeper. This may be illustrated as follows:

TABLE 9

| Blockchain | Storage Area |
|---|---|
| Block 1 Hash Value | Block 1 Hash Value . . . Content 1 |
| . . . | . . . |
| . . . | . . . |
| . . . | . . . |
| Block N Hash Value | Block N Hash Value . . . Content N |

In the example embodiment of FIG. 7C, the blockchain 970 includes a number of blocks 978₁, 978₂, . . . 978_{N} cryptographically linked in an ordered sequence, where N≥1. The encryption used to link the blocks 978₁, 978₂, . . . 978_{N} may be any of a number of keyed or un-keyed Hash functions. In one embodiment, the blocks 978₁, 978₂, . . . 978_{N} are subject to a hash function that produces n-bit alphanumeric outputs (where n is 256 or another number) from inputs that are based on information in the blocks. Examples of such a hash function include, but are not limited to: an SHA-type (SHA stands for Secured Hash Algorithm) algorithm, Merkle-Damgard algorithm, HAIFA algorithm, Merkle-tree algorithm, nonce-based algorithm, and a non-collision-resistant PRF algorithm. In another embodiment, the blocks 978₁, 978₂, . . . , 978_{N} may be cryptographically linked by a function that is different from a hash function. For purposes of illustration, the following description is made with reference to a hash function, e.g., SHA-2.

Each of the blocks 9781, 9782, . . . , 978N in the blockchain may include a header, a version of the file, and a value. The header and the value may be different for each block as a result of hashing in the blockchain. In one embodiment, the value may be included in the header. As described in greater detail below, the version of the file may be the original file or may be a different version of the original file.

The first block 9781 in the blockchain is referred to as the genesis block and may include the header 9721, original file 9741, and an initial value 9761. The hashing scheme used for the genesis block, and indeed in all subsequent blocks, may vary. For example, all the information in the first block 9781 may be hashed together and at one time, or each or a portion of the information in the first block 9781 may be separately hashed, and then a hash of the separately hashed portions may be performed.

The header 9721 may include one or more initial parameters, which, for example, may include a version number, timestamp, nonce, root information, difficulty level, consensus protocol, duration, media format, source, descriptive keywords, and/or other information associated with original file 9741 and/or the blockchain. The header 9721 may be generated automatically (e.g., by blockchain network managing software) or manually by a blockchain participant. Unlike the header in other blocks 9782 to 978N in the blockchain, the header 9721 in the genesis block may not reference a previous block, simply because there is no previous block.

The original file 9741 in the genesis block may be, for example, data as captured by a device with or without processing prior to its inclusion in the blockchain. The original file 9741 may be received through the interface of the system from the device, media source, or node. The original file 9741 may be associated with metadata, which, for example, may be generated by a user, the device, and/or the system processor, either manually or automatically. The metadata may be included in the first block 9781 in association with the original file 9741.

The value 976₁ in the genesis block may be an initial value generated based on one or more unique attributes of the original file 974₁. In one embodiment, the one or more unique attributes may include the hash value for the original file 974₁, metadata for the original file 974₁, and other information associated with the file. In one implementation, the initial value 976₁ may be based on the following unique attributes:
1) SHA-2 computed hash value for the original file
2) originating device ID
3) starting timestamp for the original file
4) initial storage location of the original file
5) blockchain network member ID for software to currently control the original file and associated metadata

The other blocks 978₂ to 978_{N} in the blockchain also have headers, files, and values. However, unlike the header 972₁ of the first block, each of the headers 972₂ to 972_{N} in the other blocks includes the hash value of an immediately preceding block. The hash value of the immediately preceding block may be just the hash of the header of the previous block or may be the hash value of the entire previous block. By including the hash value of a preceding block in each of the remaining blocks, a trace can be performed from the Nth block back to the genesis block (and the associated original file) on a block-by-block basis, as indicated by arrows 980, to establish an auditable and immutable chain-of-custody.

Each of the header 972₂ to 972_{N} in the other blocks may also include other information, e.g., version number, timestamp, nonce, root information, difficulty level, consensus protocol, and/or other parameters or information associated with the corresponding files and/or the blockchain in general.

The files 974₂ to 974_{N} in the other blocks may be equal to the original file or may be a modified version of the original file in the genesis block depending, for example, on the type of processing performed. The type of processing performed may vary from block to block. The processing may involve, for example, any modification of a file in a preceding block, such as redacting information or otherwise changing the content of, taking information away from, or adding or appending information to the files.

Additionally, or alternatively, the processing may involve merely copying the file from a preceding block, changing a storage location of the file, analyzing the file from one or more preceding blocks, moving the file from one storage or memory location to another, or performing action relative to the file of the blockchain and/or its associated metadata. Processing, which involves analyzing a file, may include, for example, appending, including, or otherwise associating various analytics, statistics, or other information associated with the file.

The values in each of the other blocks 976₂ to 976_{N} in the other blocks are unique values and are all different as a result of the processing performed. For example, the value in any one block corresponds to an updated version of the value in the previous block. The update is reflected in the hash of the block to which the value is assigned. The values of the blocks, therefore, provide an indication of what processing was performed in the blocks and also permit a tracing through the blockchain back to the original file. This tracking confirms the chain-of-custody of the file throughout the entire blockchain.

For example, consider the case where portions of the file in a previous block are redacted, blocked out, or pixelated in order to protect the identity of a person shown in the file. In this case, the block, including the redacted file, will include metadata associated with the redacted file, e.g., how the redaction was performed, who performed the redaction, timestamps where the redaction(s) occurred, etc. The metadata may be hashed to form the value. Because the metadata for the block is different from the information that was hashed to form the value in the previous block, the values are different from one another and may be recovered when decrypted.

In one embodiment, the value of a previous block may be updated (e.g., a new hash value computed) to form the value of a current block when any one or more of the following occurs. The new hash value may be computed by hashing all or a portion of the information noted below, in this example embodiment.
a) new SHA-2 computed hash value if the file has been processed in any way (e.g., if the file was redacted, copied, altered, accessed, or some other action was taken)
b) new storage location for the file
c) new metadata identified associated with the file
d) transfer of access or control of the file from one blockchain participant to another blockchain participant

FIG. 9D illustrates an embodiment of a block, which may represent the structure of the blocks in the blockchain 990, consistent with some embodiments. The block, Blockᵢ, may include a header 972ᵢ, a file 974ᵢ, and a value 976ᵢ.

The header 972i may include a hash value of a previous block Blockᵢ₋₁ and additional reference information, which, for example, may be any of the types of information (e.g., header information including references, characteristics, parameters, etc.) discussed herein. All blocks in some embodiments may reference the hash of a previous block except the genesis block in some embodiments. The hash value of the previous block may be just a hash of the header in the previous block or a hash of all or a portion of the information in the previous block, including the file and metadata.

The file 974ᵢ may include a plurality of data, such as Data 1, Data 2, . . . , Data N in sequence. The data are tagged with Metadata 1, Metadata 2, . . . , Metadata N, which describe the content and/or characteristics associated with the data. For example, the metadata for each data may include: information to indicate a timestamp for the data, process the data, keywords indicating the persons or other content depicted in the data, and/or other features that may be helpful to establish the validity and content of the file as a whole, and particularly its use a digital evidence, for example, as described in connection with an embodiment discussed below. In addition to the metadata, each data may be tagged with reference REF1, REF2, REFN to a previous data to prevent tampering, gaps in the file, and sequential reference through the file.

Once the metadata is assigned to the data (e.g., through a smart contract), the metadata cannot be altered without the hash changing in some embodiments, which can easily be identified for invalidation. The metadata in these embodiments, thus, creates a data log of information that may be accessed for use by participants in the blockchain.

The value 976ᵢ in some embodiments may be a hash value or other value computed based on any of the types of information previously discussed. For example, for any given block Blockᵢ, the value for that block may be updated to reflect the processing that was performed for that block, e.g., new hash value, new storage location, new metadata for the associated file, transfer of control or access, identifier, or other action or information to be added. Although the value in each block is shown to be separate from the metadata for the data of the file and header, the value may be based, in part or whole, on this metadata in another embodiment.

Once the blockchain 970 is formed, at any point in time, the immutable chain-of-custody for the file may be obtained by querying the blockchain for the transaction history of the values across the blocks in some embodiments. This query, or tracking procedure, may begin with decrypting the value of the block that is most currently included (e.g., the last (Nth) block), and then continuing to decrypt the value of the other blocks until the genesis block is reached and the original file is recovered. The decryption may involve decrypting the headers and files and associated metadata at each block, as well.

Decryption may be performed based on the type of encryption that took place in each block. This may involve the use of private keys, public keys, or a public key-private key pair. For example, when asymmetric encryption is used, blockchain participants or a processor in the network may generate a public key and private key pair using a predetermined algorithm. The public key and private key may be associated with each other through some mathematical relationship. The public key may be distributed publicly to serve as an address to receive messages from other users, e.g., an IP address or home address. The private key may be kept secret and may be used to digitally sign messages sent to other blockchain participants. The signature, in turn, may be included in the message so that the recipient can verify using the public key of the sender. This way, the recipient can be confident that only the sender could have sent this message.

In some embodiments, generating a key pair may be analogous to creating an account on the blockchain, but without having to actually register anywhere. In these embodiments, every transaction that is executed on the blockchain may be digitally signed by the sender using their private key. This signature may help ensure that only the owner of the account can track and process (if within the scope of permission determined by a smart contract) the file of the blockchain.

### Computer Program Product

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

### General

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

Therefore, it is desired that the embodiments described herein be considered in all respects as illustrative, not restrictive, and that reference be made to the appended claims for determining the scope of the invention.

What is claimed is:

1. A method, comprising:
receiving, by a network interface, a customer order for a food item, wherein the customer order includes a desired taste profile and a desired future consumption date range;
automatically identifying, by an artificial intelligence enabled system (AICS), one or more compatible combinations of delivery routes and delivery items responsive to the customer order;
automatically selecting, by the AICS, a preferred delivery route and a preferred delivery item from among the one or more compatible combinations based at least in part on the desired taste profile and the desired future consumption date range; and
sending, by the network interface, instructions to route the preferred delivery item to the customer using the preferred delivery route.

2. The method of claim 1, wherein the desired taste profile comprises a reference food item that the customer has previously received.

3. The method of claim 1, wherein the desired taste profile comprises a plurality of taste profiles having values that were measured using an electronic taste measuring instrument.

4. The method of claim 1, wherein the desired consumption date comprises an estimated rate of consumption and a desired consumption date range.

5. The method of claim 4, further comprising automatically calculating, by the AICS, an amount of food items that can be delivered in a single transit consistent with the desired taste profile through the desired consumption date range.

6. The method of claim 5, further comprising automatically selecting, by the AICS, a plurality of preferred delivery items having different maturity characteristics.

7. The method of claim 1, wherein automatically identifying the one or more compatible combinations of delivery routes and delivery items comprises identifying a maturity state of the food items to satisfy the desired taste profile on the desired future consumption date.

8. The method of claim 1, further comprising training the AICS, wherein the training comprises receiving labeled data; and wherein the labeled data comprises vectors comprising historic taste profiles, transportation duration, modes of transportation, geo-location where the food items were cultivated, and weather condition during a growth cycle of the food item.

9. The method of claim 8, further comprising retrieving the labeled data from a blockchain.

10. The method of claim 8, wherein automatically identifying the one or more compatible combinations of delivery routes and delivery items comprises: identifying a compatible growth source location, a compatible mode of transportation, a compatible supply chain route, a compatible type of preparation, and a compatible preservation method to satisfy the desired taste profile.

11. The method of claim 1, further comprising:
generating recommendations to preserve and sequence food items to get the desired taste profile within the desired future consumption date range; and
transmitting, by the network interface, the recommendations to the customer.

12. A computer program product comprising, a computer readable storage medium having program instructions embodied therewith, the program instructions executable by a processor to cause the processor to:
receive labeled data from a blockchain, wherein the labeled data comprises vectors comprising historic taste profiles, transportation duration, modes of transportation, geo-location where the food items were cultivated, and weather condition during a growth cycle of the food item;
receive a customer order for a food item, wherein the customer order includes a desired taste profile and a desired future consumption date range, wherein:
the desired consumption date comprises an estimated rate of consumption and a desired consumption date range; and
the desired taste profile comprises a reference food item that the customer has previously received;
calculate an amount of food items that can be delivered in a single transit consistent with the desired taste profile through the desired consumption date range using the labeled data;
identify one or more maturity states of the food items to satisfy the desired taste profile on the desired future consumption date based at least in part on the calculated amount of food items and the labeled data;
automatically identify one or more compatible combinations of delivery routes and delivery items responsive to the customer order based at least in part on the one or more maturity states, a compatible growth source location, a compatible mode of transportation, a compatible supply chain route, a compatible type of preparation, and a compatible preservation method to satisfy the desired taste profile;
automatically select a preferred delivery route and one or more preferred delivery items from among the one or more compatible combinations based at least in part on the desired taste profile and the desired future consumption date range; and
send instructions to route the preferred delivery item to the customer using the preferred delivery route.

13. An artificial intelligence enabled system (AIES) comprising a processor configured to execute instructions that, when executed on the processor, cause the processor to:
receive a customer order for a food item, wherein the customer order includes a desired taste profile and a desired future consumption date range;
automatically identify one or more compatible combinations of delivery routes and delivery items responsive to the customer order;
automatically select a preferred delivery route and a preferred delivery item from among the one or more compatible combinations based at least in part on the desired taste profile and the desired future consumption date range; and
sending instructions to route the preferred delivery item to the customer using the preferred delivery route.

14. The system of claim 13, wherein the desired consumption date comprises an estimated rate of consumption and a desired consumption date range.

15. The system of claim 14, further comprising instructions that cause the processor to automatically calculate an amount of food items that can be delivered in a single transit consistent with the desired taste profile through the desired consumption date range.

16. The system of claim 15, further comprising instructions that cause the processor to automatically select a plurality of preferred delivery items having different maturity characteristics.

17. The system of claim 13, wherein automatically identifying the one or more compatible combinations of delivery routes and delivery items comprises identifying a maturity state of the food items to satisfy the desired taste profile on the desired future consumption date.

18. The system of claim 13, further comprising instructions that cause the processor to train the AICS, wherein the training comprises receiving labeled data; and wherein the labeled data comprises vectors comprising historic taste profiles, transportation duration, modes of transportation, geo-location where the food items were cultivated, and weather condition during a growth cycle of the food item.

19. The system of claim 18, further comprising retrieving the labeled data from a blockchain.

20. The system of claim 19, wherein automatically identifying the one or more compatible combinations of delivery routes and delivery items comprises: identifying a compatible growth source location, a compatible mode of transportation, a compatible supply chain route, a compatible type of preparation, and a compatible preservation method to satisfy the desired taste profile.
